(19) United States
(12) Patent Application Publication
(10) Pub. No.: US 2020/0374050 A1
(43) Pub. Date: Nov. 26, 2020

(54) Inter-Radio Access Technology Carrier Aggregation

(71) Applicant: Google LLC, Mountain View, CA (US)

(72) Inventors: Jibing Wang, Saratoga, CA (US); Erik Richard Stauffer, Sunnyvale, CA (US); Aamir Akram, San Jose, CA (US)

(73) Assignee: Google LLC, Mountain View, CA (US)

(21) Appl. No.: 16/769,195

(22) PCT Filed: Jul. 11, 2018
(86) PCT No.: PCT/US2018/041696

§ 371 Date: Jun. 2, 2020

Related U.S. Application Data
(63) Continuation of application No. 15/832,395, filed on Dec. 5, 2017.

(51) Int. Cl. H04L 1/20; H04L 5/00; H04L 25/06; H04L 1/18; H04W 88/06; H04W 88/10

(52) U.S. Cl. CPC H04L 1/201; H04L 5/0055; H04L 25/067; H04L 1/1867; H04L 1/0025; H04W 88/06; H04W 88/10; H04L 5/0096; H04L 5/0085; H04L 5/001

(57) ABSTRACT

The present disclosure describes methods and apparatuses for inter-radio access technology carrier aggregation. In some aspects, a user device establishes a wireless link for communicating with a base station via a first radio access technology. The user device receives an inter-radio access technology carrier aggregation communication via the wireless link in accordance with the first radio access technology. The inter-radio access technology carrier aggregation communication includes data relating to a component carrier of the wireless link that uses a second radio access technology. The user device may use the data to configure the user device for communication via the second component carrier of the wireless link.

### BACKGROUND

Many user devices communicate over a wireless network provided by network nodes. Because of advances in wireless standards, user devices may be configurable to communicate, via the wireless network, using multiple wireless standards. For example, when a user device is out of range of a wireless link to the wireless network using a state-of-the-art radio access technology (RAT), the user device may instead communicate with the wireless network using a less-advanced RAT. However, most user devices are configured to communicate wirelessly using only a single wireless standard at a time.

As part of communicating over the wireless network, user devices send and receive communication data, such as wireless link configuration data, wireless link control data, status indications, queries, feedback, or scheduling requests. This communication data uses communication resources of the wireless link and reduces an amount of resources that could otherwise be used for communication of application data.

The problem solved by this invention may therefore be regarded as improving the use of communication resources in a wireless network.

### SUMMARY

This document describes techniques for, and systems that enable, inter-radio access technology carrier aggregation (“inter-RAT carrier aggregation” or “Inter-RAT CA”), for aggregating component carriers of a wireless link. In some aspects, the techniques include providing, via a first component carrier of a first RAT, an Inter-RAT CA communication that provides data related to a second component carrier of a second RAT. The Inter-RAT CA communication may be sent from a user device to a base station via the first component carrier, or may be sent from the base station to the user device. The Inter-RAT CA communication may be used by the user device to configure a transceiver of the user device for communication via the second component carrier of the second RAT. The user device may then communicate via both of the first component carrier of the first RAT and the second component carrier of the second RAT.

The base station may send further Inter-RAT CA communications to the user device via the first component carrier that are related to the second component carrier of the second RAT. For example, the base station may send to the user device communication data such as wireless link configuration data, wireless link control data, status indications, queries, feedback, instructions, or scheduling requests. More specifically, the communication data may include a timing advance, a power control command, an indication of capabilities to support Inter-RAT CA communications, an activation command, or a deactivation command. The user device may send further Inter-RAT CA communications to the base station via the first component carrier, with the communications related to the second component carrier. For example, the user device may send to the base station a buffer status report, acknowledge/not acknowledge data, or user selection data relating to the second component carrier.

These techniques and systems may be implemented, for instance, in wireless networks that implement two or more wide-band (e.g., 20 MHz to 1 GHz) communication protocols, such as a 4th generation (4G) Long Term Evolution (LTE) wireless network, an LTE advanced wireless network, or a 5th generation (5G) new radio (NR) wireless network. These techniques and systems may be particularly beneficial to aggregate an advanced cellular network protocol, such as the 5G NR system, with a less-advanced RAT. A component carrier of the less-advanced RAT of a wireless link can be used to communicate instructions and communication data for another component carrier of a 5G NR RAT, thereby making available additional resources of the other component carrier of the 5G NR RAT for communicating application data.

In this way the communication resources of both the first and second base stations (and both first and second RATs) may be utilized by a user device. This can result in more efficient utilization of available resources and improved bandwidth for the user device.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

A method performed by a user device is provided. The method comprises establishing, via a transceiver of the user device, a wireless link with a first base station via a first radio access technology (RAT). The method further comprises transmitting, to the first base station via the first RAT, a message indicating that the user device supports communication via a second RAT. The second RAT is different from the first RAT. The method further comprises receiving, from the first base station via the first RAT, an inter-RAT carrier aggregation communication that provides data related to a component carrier of the second RAT. The method further comprises configuring, based at least in part on the inter-RAT carrier aggregation communication, the transceiver of the user device for communicating via a component carrier of the first RAT. The method further comprises configuring, based at least in part on the inter-RAT carrier aggregation communication, the transceiver of the user device for communicating via the component carrier of the second RAT. The method further comprises communicating, via the configured transceiver, data with both the first base station via the first component carrier of the first RAT and a second base station via the second component carrier of the second RAT.

The second component carrier may be configured for communication with the second base station via a downlink only.

The first RAT may be a Long Term Evolution (LTE) RAT and the second RAT may be a fifth generation (5G) new radio (NR) RAT. Alternatively, the first RAT may be a 5G NR RAT and the second RAT may be an LTE RAT.

The inter-RAT carrier aggregation communication received via the first RAT may include a timing advance usable by the user device to configure transmission timing for communication via the second component carrier of the second RAT.

The inter-RAT carrier aggregation communication received via the first RAT may include a power control command usable by the user device to adjust a power amplification for transmitting via the second component carrier of the second RAT.

The inter-RAT carrier aggregation communication may be received by the user device via a physical random access channel (PRACH) configuration message and may be usable by the user device to configure the user device to establish another PRACH with the second component carrier of the second RAT.

The inter-RAT carrier aggregation communication may include an indication that the first base station supports aggregation communications for the first component carrier of the first RAT and the second component carrier of the second RAT.

The inter-RAT carrier aggregation communication may include handover data usable by the user device to transfer the second component carrier from the second base station to another base station.

The inter-RAT carrier aggregation communication may be received by the user device as part of a carrier identification field (CIF) of the first component carrier of the first RAT.

The inter-RAT carrier aggregation communication may be received by the user device as part of a radio resource control (RRC) communication of the first component carrier of the first RAT.

A user device is also provided. The user device comprises a hardware-based transceiver and an inter-radio access technology carrier aggregation (Inter-RAT CA) module. The Inter-RAT CA module is configured to establish, via the transceiver of the user device, a wireless link with one or more base stations. The wireless link includes a first component carrier of a first radio access technology (RAT) and a second component carrier of a second RAT. The second RAT is different from the first RAT. The Inter-RAT CA module is further configured to receive, from the one or more base stations and via the first component carrier of the first RAT, an inter-RAT carrier aggregation communication providing data relating to the second component carrier of the second RAT. The Inter-RAT CA module is further configured to alter, in response to receiving the inter-RAT carrier aggregation communication, a configuration of the second component carrier of the second RAT.

The second component carrier of the second RAT may support a greater downlink bandwidth than a downlink bandwidth supported by the first component carrier of the first RAT.

The inter-RAT carrier aggregation communication may include a deactivation message instructing the user device to deactivate the second component carrier of the second RAT.

The Inter-RAT CA module may be further configured to transmit a buffer status report via the first component carrier of the first RAT. The buffer status report may include a status of data to be transmitted via the second component carrier of the second RAT.

A method performed by a base station of a wireless network is also provided. The method comprises establishing, via a transceiver of the base station, a wireless link for communicating with a user device, the wireless link including a first component carrier of a first radio access technology (RAT) facilitating communication between the base station and the user device. The method further comprises determining that the user device supports a second component carrier of a second RAT. The method further comprises receiving, from another device of the wireless network, data relating to the second component carrier of the second RAT. The method further comprises transmitting, to the user device via the first component carrier of the first RAT, an inter-RAT carrier aggregation communication providing at least a portion of the data relating to the second component carrier of the second RAT. The portion of the data is usable by the user device to configure a transceiver of the user device for future communication via the second component carrier of the second RAT.

The inter-RAT carrier aggregation communication may include a measurement report configuration useable by the user device to transmit a measurement report via the wireless link. The measurement report may include signal quality data for the second component carrier of the second RAT.

The measurement report configuration may be useable by the user device to transmit the measurement report via the first component carrier of the second RAT.

The inter-RAT carrier aggregation communication may be transmitted to the user device as part of a radio resource control (RRC) connection reconfiguration.

The RRC connection reconfiguration may be useable by the user device to terminate the other wireless link.

The inter-RAT carrier aggregation communication may include an RRC message useable by the user device to configure a maximum power amplification for communicating via the other wireless link.

A base station configured to perform any of the methods described above is also provided.

A computer readable storage medium or computer program comprising instructions that, when executed by a processor, cause the processor to perform any of the methods described above is also provided.

### BRIEF DESCRIPTION OF THE DRAWINGS

The details of one or more aspects of inter-radio access technology carrier aggregation for wireless networks is described below. The use of the same reference numbers in different instances in the description and the figures may indicate like elements:

FIG. 1 illustrates example device configurations of a user device and a base station in accordance with one or more aspects of inter-radio access technology carrier aggregation.

FIG. 2 illustrates an example networking environment in which the user device and base station may communicate in accordance with one or more aspects of inter-radio access technology carrier aggregation.

FIG. 3 illustrates an example of network communication or operations in accordance with one or more aspects of inter-radio access technology carrier aggregation.

FIG. 4 illustrates another example of network communication or operations in accordance with one or more aspects of inter-radio access technology carrier aggregation.

FIG. 5 illustrates an example user interface of a user device through which one or more aspects of inter-radio access technology carrier aggregation can be implemented.

FIG. 6 illustrates an example method for inter-radio access technology carrier aggregation.

FIG. 7 illustrates another example method for inter-radio access technology carrier aggregation.

FIG. 8 illustrates another example method for inter-radio access technology carrier aggregation.

### DETAILED DESCRIPTION

Generally, a user device communicates with a wireless network through a wireless link. The wireless link often includes one or more component carriers, which use radio access technologies (RATs) for communication. The wireless network includes network nodes, such as base stations, which transmit and receive data with a user device via one of the component carriers using a single RAT. As part of communicating via the component carrier, the base station and the user device share other communication data. The communication data use communication resources, however, that could otherwise be used for communication of application data.

This document describes techniques and systems for inter-radio access technology carrier aggregation. These techniques include providing, via a first component carrier of a first RAT, communication data of a second component carrier. In an example implementation of inter-radio access technology carrier aggregation, a user device establishes a wireless link with a base station via a first component carrier using a first RAT, such as 4G LTE. The user device transmits to the base station an indication that the user device supports a second component carrier using a second RAT, such as 5G NR. The user device then receives an inter-RAT carrier aggregation (CA) communication from the base station via the first component carrier using the first RAT. Upon receiving the Inter-RAT CA communication, the user device configures a transceiver for communication with a second base station via the second component carrier and with the first base station via the first component carrier.

In other aspects, a base station can establish a wireless link with a user device via a first component carrier using a first RAT. The base station then determines that the user device supports a second component carrier using a second RAT. The base station may determine this by receiving an indication from the user device via the first component carrier, another base station, or a mobility management entity that manages a network of base stations. The data relating to the second component carrier can include communication data for communication between the user device and the other base station via the second component carrier using the second RAT.

The following discussion describes an operating environment, an example networking environment in which devices of the operating environment may be implemented, and techniques that may be employed in one or both of the operating environment or network environment. In the context of the present disclosure, reference is made to the operating environment or networking environment by way of example only.

Operating Environment

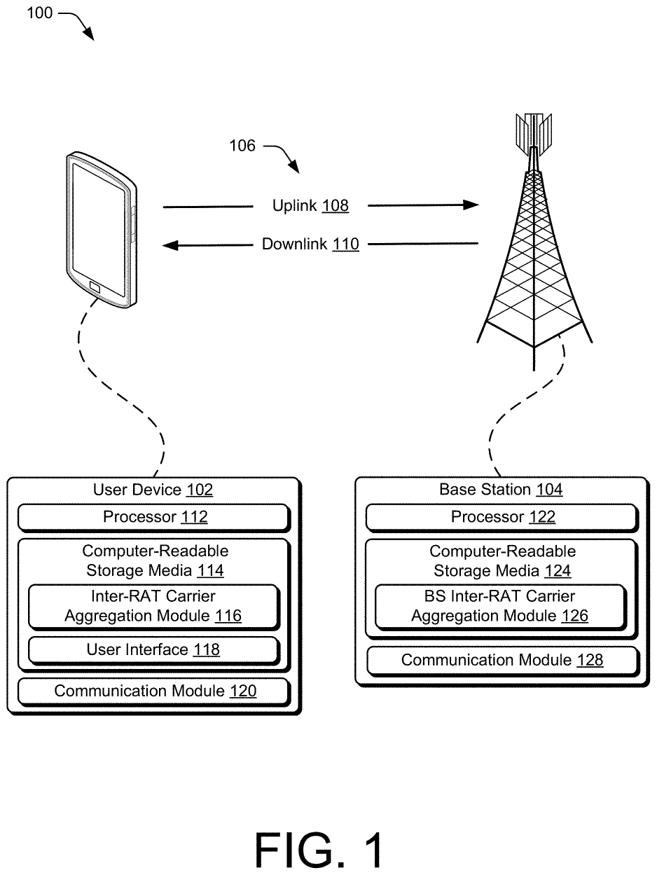

FIG. 1 illustrates an example operating environment 100 in which devices for Inter-RAT CA can be implemented. In this example, the operating environment includes a user device 102 and a base station 104 that are respectively configured to communicate over a wireless link 106 of a wireless network. Generally, the wireless link 106 includes an uplink 108 by which the user device 102 transmits data or information to the base station 104 and a downlink 110 by which the base station 104 transmits other data or other information to the user device 102. The wireless link 106 may be implemented in accordance with any suitable protocol or standard, such as a Global System for Mobile Communications (GSM), Worldwide Interoperability for Microwave Access (WiMax), a High Speed Packet Access (HSPA), Evolved HSPA (HSPA+) protocol, an LTE protocol (e.g., 4G), an LTE Advanced protocol, 5G NR, or the like. Although shown or described with reference to a separate uplink 108 or downlink 110, communication between the user device 102 and base station 104 may also be referred to as a wireless connection, wireless association, frame exchange, communication link, or the like.

The user device 102 includes a processor 112, computer-readable storage media 114 having an Inter-RAT CA module 116 and a user interface 118, and a communication module 120. The user device 102 is illustrated as a smart phone, however the user device 102 may instead be implemented as any device with wireless communication capabilities, such as a mobile gaming console, a tablet, a laptop, an advanced driver assistance system (ADAS), a point-of-sale (POS) terminal, a health monitoring device, a drone, a camera, a media-streaming dongle, a wearable smart-device, an internet-of-things (IoT) device, a personal media device, a navigation device, a mobile-internet device (MID), a wireless hotspot, a femtocell, or a broadband router.

The processor 112 of the user device 102 can execute processor-executable instructions or code stored by the computer-readable storage media (CRM) 114 to cause the user device 102 to perform operations or implement various device functionalities. In some cases, the processor 112 is implemented as an application processor (e.g., multicore processor) or a system-on-chip with other components of the user device 102 integrated therein. The CRM 114 may include any suitable type of memory media or storage media, such as read-only memory (ROM), programmable ROM (PROM), random access memory (RAM), static RAM (SRAM), or flash memory. In the context of this discussion, the CRM 114 of the user device 102 is implemented as hardware-based storage media, which does not include transitory signals or carrier waves. In some cases, the CRM 114 stores one or more of firmware, an operating system, or applications of the user device 102 as instructions, code, or information. The instructions or code can be executed by the processor 112 to implement various functionalities of the user device 102, such as those related to network access or audio encoding features. In this example, the CRM 114 also stores processor-executable code or instructions for implementing one or more of the Inter-RAT CA module 116 or the user interface 118 the user device 102.

In some aspects, the Inter-RAT CA module 116 may prepare communication data for communication via a first component carrier of the wireless link 106 using a first RAT. The communication data may include communication data related to one or both of the first component carrier using the first RAT and a second component carrier of the wireless link 106 using a second RAT that is different from the first RAT. The Inter-RAT CA module 116 thus aggregates communication data relating to a first carrier component of a first RAT with those of a second carrier component of a second RAT. The Inter-RAT CA module 116 then transmits, via the communication module 120, the aggregated communication data to the base station 104.

The communication data may include, for example, device status information, wireless link status information, wireless link control information, data requests, instructions, or network access requests. More specifically, the communication data may include a buffer status report including a status of data to be transmitted via the second component carrier of the second RAT. Additionally or alternatively, the communication data includes a measurement report including signal quality data for the second component carrier of the second RAT. Further, the communication data may include acknowledge/not acknowledge (ACK/NACK) data. The communication data may be transmitted via various communication channels of the uplink 108, such as a physical uplink control channel (PUCCH) or a physical uplink share channel (PUSCH). Further, the communication data may be transmitted as a unique communication, a portion of a preamble, or medium access control (MAC) layer of a communication packet.

The user interface 118 may provide a notification of carrier aggregation of multiple component carriers of different RATs. Additionally or alternatively, the user interface 118 may provide a menu for receiving a selection to enter an Inter-RAT CA mode. These are but a few implementations of the Inter-RAT CA module 116 and the user interface 118, which are described further or with other aspects throughout the disclosure.

The communication module 120 of the user device 102 includes a receiver, a transmitter, and associated circuitry or other components for communicating with the base station 104 via a wireless medium. For example, the communication module 120 may transmit, via the transmitter, data or information to the base station 104 via the uplink 108. This data or information transmitted to the base station 104 may include any suitable type of framed or packetized information, such as device status information, wireless link status information, wireless link control information, data requests, data, network access requests, or the like. The communication module 120 may also receive, via the receiver, other data or other information from the base station 104, such as wireless link configuration settings, network control information, or communication mode selection.

In this example, the base station 104 is shown generally as a cellular base station of a wireless network. The base station 104 may be implemented to manage a cell of a wireless network that includes multiple other base stations that each manage another respective cell of the wireless network. As such, the base station 104 may communicate with a network management entity or others of the multiple base stations to coordinate connectivity or hand-offs of mobile stations within or across the cells of the wireless network. The base station 104 can be configured as any suitable type of base station or network management node, such as GSM base station, a node base (Node B) transceiver station (e.g., for UMTS), an evolved NodeB (eNB, e.g., for LTE), or a next generation Node B (gNB, e.g., for 5G NR), or the like. As such, the base station 104 may control or configure parameters of the uplink 108 or the downlink 110 in accordance with one or more of the wireless standards or protocols described herein.

The base station 104 includes a processor 122, a computer-readable storage media (CRM) 124 having a base station (BS) inter-RAT carrier aggregation module 126, and a communication module 128. The processor 122 can execute processor-executable instructions or code stored by the CRM 124 to perform operations or implement various base station functionalities. In some cases, the processor 122 is implemented as multiple processor cores or a multicore processor configured to execute firmware or an operating system of the base station 104. The CRM 124 may include any suitable type of memory media or storage media, such as ROM, PROM, RAM, SRAM, or flash memory. In the context of this discussion, the CRM 124 is implemented as hardware-based storage media, which does not include transitory signals or carrier waves. The CRM 124 of the base station 104 may store firmware, an operating system, or applications of the base station 104 as instructions, code, or other information. The instructions or code can be executed by the processor 122 to implement various functionalities of the base station 104, such as to manage connectivity or parameters of the wireless link 106 with the user device 102. In this example, the CRM 124 also stores processor-executable code or instructions for implementing the base station inter-RAT carrier aggregation module 126 of the base station 104.

In some aspects, the base station inter-RAT carrier aggregation module 126 of the base station 104 is implemented to perform various functions associated with Inter-RAT CA for a first component carrier of a first RAT and a second component carrier of a second RAT. The base station inter-RAT carrier aggregation module 126 is executable by the processor 122 to aggregate communication data for communication over a first component carrier of a first RAT between the user device 102 and the base station 104. The communication data include data relating to communication over a second component carrier of a second RAT. The communication over the second component carrier of the second RAT may be between the user device 102 and a different transceiver of the base station 104, or between the user device 102 and another base station.

The communication data transmitted by the base station 104 may include, for example, wireless link status information, wireless link control information, or the like. More specifically, the communication data may include radio resource control (RRC) connection configuration (or reconfiguration) message to add or remove another component carrier. For example, the RRC connection configuration message may include parameters of the component carrier to add. The parameters may include one or more of an identification of a RAT, a bandwidth, a component carrier frequency, an orthogonal frequency-division multiplexing (OFDM) numerology or scheme, or antenna information. Additionally or alternatively, the communication data may include a carrier activation or deactivation message via a medium access control (MAC) control element. The carrier activation message instructs the user device 102 to activate communication via the second component carrier and may include related instructions. The carrier deactivation message instructs the user device 102 to deactivate, or terminate, communication via the second component carrier and may include related instructions.

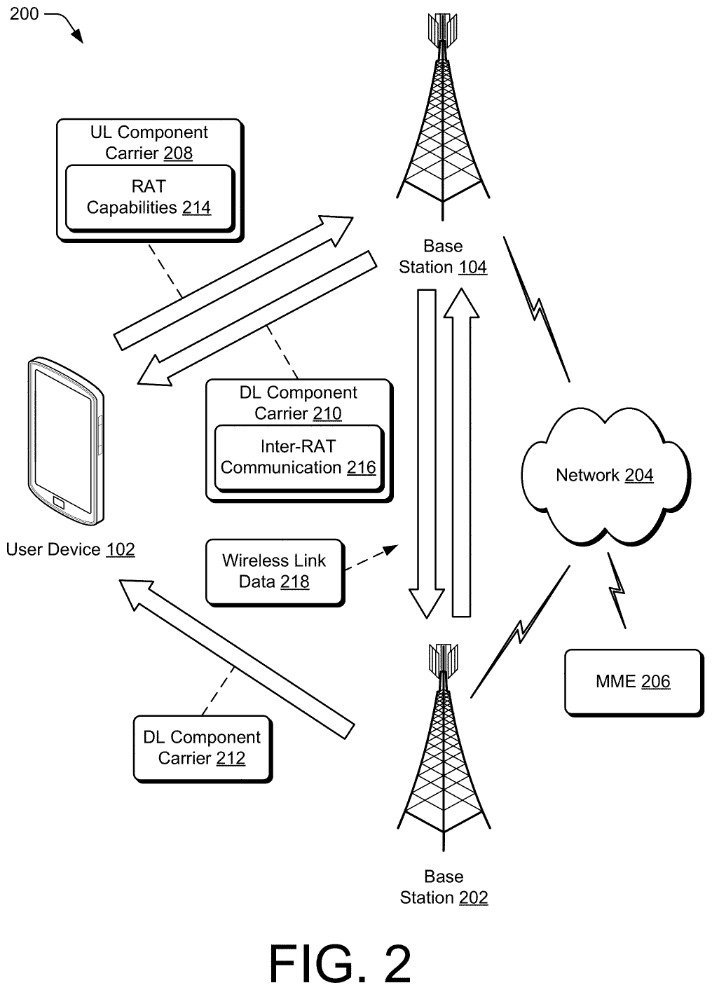

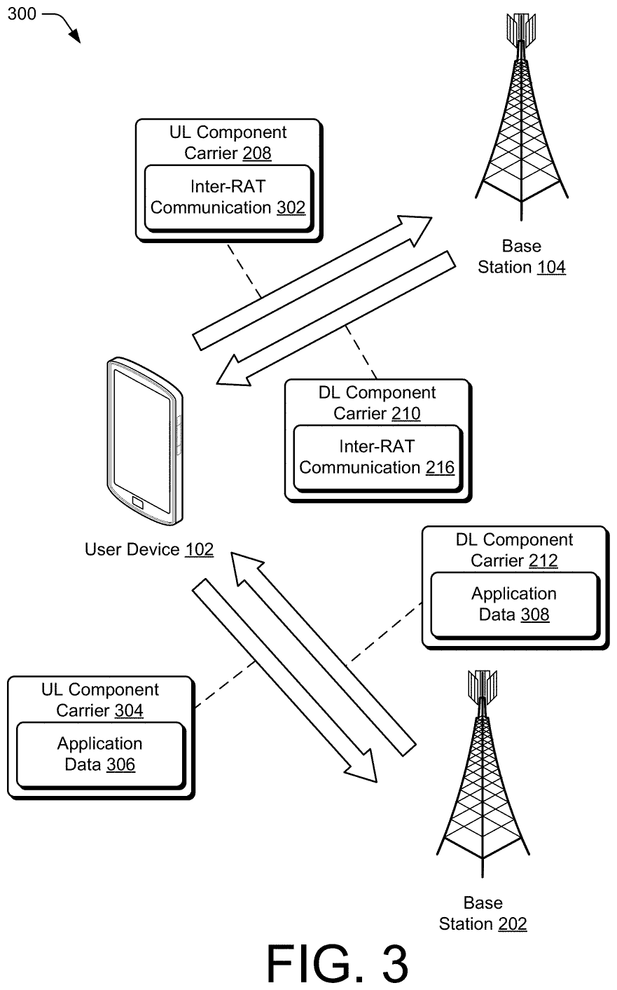

When the wireless link 106 includes a first component carrier of a first RAT and a second component carrier of a second RAT, additional communication data may be transmitted by the base station 104 as additional inter-RAT carrier aggregation communications. For example, additional communication data may include a timing advance usable by the user device 102 to configure transmission timing for communication via the second component carrier of the second RAT. Additionally or alternatively, the additional communication data may include a power control command usable by the user device 102 to adjust a maximum power amplification for transmitting via the second component carrier of the second RAT. Further, the additional communication data may include an indication that the base station 104 supports carrier aggregation communications for the first component carrier of the first RAT and the second component carrier of the second RAT. In some implementations, the additional communication data include handover data usable by the user device 102 to transfer the second component carrier from the base station 104 to another base station (as shown in FIGS. 2 and 3). In other examples, the additional communication data include a measurement report configuration that is useable by the user device 102 to transmit a measurement report via the wireless link 106. The measurement report includes signal quality data for the second component carrier of the second RAT. The measurement report may be transmitted via the first or second component carrier of the wireless link 106.

The communication data may be transmitted via various communication channels of the downlink 110, such as a physical downlink control channel (PDCCH), a physical random access channel (PRACH) configuration message, a hybrid automatic repeat requests (HARQ) Physical HARQ indicator channel (PHICH), or a physical downlink share channel (PDSCH). The communication data may include channel configuration instructions that are usable by the user device 102 to configure additional channels for communication via the first component carrier of the first RAT or the second component carrier of the second RAT. For example, the communication data may be usable by the user device 102 to configure another PHICH for communication via the second component carrier of the second RAT.

Further, the communication data may be transmitted as a unique communication, a portion of a preamble, or MAC layer of a communication packet. The communication data may be transmitted via various communication channels of the downlink 110 as part of a radio resource control (RRC) message, a Downlink Control Information (DCI) message, or a carrier identification field (CIF) of the first component carrier of the first RAT.

The communication module 128 of the base station 104 includes a receiver, a transmitter, and associated circuitry or other components for communicating with the user device 102 via the wireless medium. In some cases, the communication module 128 includes, or is coupled with, multiple transceivers and antenna arrays that are configured to establish and manage wireless links with multiple user devices or mobile stations. The base station 104 may communicate any suitable data or information to the user device 102 (or other mobile stations) through the downlink 110, such as a schedule of allocated resource elements, data, wireless link status information, or wireless link control information.

FIG. 2 illustrates an example networking environment 200 in which a user device and two base stations may communicate via inter-RAT carrier aggregation. The network environment 200 includes respective instances of the user device 102 and the base station 104, which provides a first component carrier of a wireless network with which the user device 102 and other mobile stations may associate. The wireless network includes a second base station 202, which provides a second component carrier of the wireless network with which the user device 102 and other mobile stations may associate. Through the wireless network, the base station 104 and the base station 202 may provide access to other networks or resources, such as a network 204 (e.g., the Internet) connected via a backhaul link (e.g., fiber network). Alternately or additionally, the networking environment 200 may include additional base stations or a mobility management entity (MME) 206 to manage the base stations of the wireless network and provide an area wide wireless network, such as a multi-component carrier network, and associated data services. For example, the MME 206 may manage the base station 104 and the base station 202 such that the base station 104 provides a first component carrier of a first RAT and the base station 202 provides a second component carrier of a second RAT. An uplink (UL) component carrier 208 and a downlink (DL) component carrier 210 are collectively referred to as a first component carrier. A second component carrier includes a downlink (DL) component carrier 212. In some implementations, the second component carrier also includes an uplink component carrier.

In the context of Inter-RAT CA, the user device 102 communicates, via the uplink (UL) component carrier 208, RAT capabilities 214 of the user device 102 to the base station 104. The RAT capabilities 214 may be communicated as part of a request for Inter-RAT CA. The base station 104 communicates, via the downlink (DL) component carrier 210, an inter-RAT communication 216. The inter-RAT communication 216 may be an Inter-RAT CA communication, as described herein.

In an example implementation, the first component carrier of the wireless link uses a 4G LTE RAT. The second component carrier of the wireless like uses a 5G NR RAT. This allows for the second component carrier, which has a greater downlink bandwidth than the first component carrier, to be dedicated to communication of data from the network 204 to the user device 102 without requiring network resources for communication of data from the user device 102 to the base station 202. This may be beneficial for a wireless link with a high downlink volume. For example, if the user device is streaming a video, transmitting, via the first component carrier, communication data for the second component carrier increases a bandwidth for downloading the video stream via the second component carrier.

In another example, the first component carrier of the wireless link uses a 5G NR RAT and the second component carrier uses a 4G LTE RAT. This allows for the second component carrier, which has a smaller downlink bandwidth than the first component carrier, to be dedicated to communication of data from the network 204 to the user device 102 without requiring network resources for communication of data from the user device 102 to the base station 202. This may be beneficial when using the second component carrier to provide background data, not requiring a large bandwidth, to the user device 102. Additionally, this may be beneficial when using the second component carrier to provide a constant, or near constant, flow of data to the user device 102.

The base station 104 and the base station 202 exchange wireless link data 218 via a wireless or wired connection, which may be used to coordinate Inter-RAT CA communications. For example, the user device 102 may transmit communication data to the base station 104 that are related to the downlink (DL) component carrier 212 of the second component carrier for communication between the base station 202 and the user device 102. The base station 104 then transmits the communication data to the base station 202. This may be via a direct communication from the base station 104 to the base station 202, or may be through the network 204. As shown, the component carrier for communication between the base station 202 and the user device 102 does not include an uplink component carrier, so the user device 102 instead communicates to the base station 202 through the base station 104. This makes available resources of the second component carrier for the downlink component carrier 212.

The user device 102 and the base stations 104 and 202 may communicate through any suitable type or combination of channels, message exchanges, or network management procedures. For example, the user device 102 may communicate to one or both of the base station 104 or 202 via a PUCCH. The PUCCH may be useful to transmit, to the base stations 104 or 202, one or more of HARQ ACK/NACK, channel quality indicators (CQI), multiple-input-multiple-output (MIMO) feedback such as a rank indicator (RI) or a precoding matrix indicator (PMI), scheduling requests for uplink transmission, or binary phase-shift keying (BPSK) or quadrature phase-shift keying (QPSK) for PUCCH modulation.

The base stations 104 or 202 may communicate with the user device 102 via a PDCCH. The PDCCH can be used by the base stations 104 or 202 to communicate DCI or an RRC message to the user device 102. In some aspects, the DCI includes identification of wireless link resources to be used for communication of data to the user device 102. The DCI may also include a modulation scheme and coding/decoding information for the user device 102 to access the data communicated to the user device 102 via the downlink component carrier 210 or the downlink component carrier 212. The base stations 104 or 202 may communicate additional data to the user device 102 via a PDSCH. For example, application data such as video streaming, media sharing, or gaming data can be transmitted to the user device 102 via the PDSCH.

The user device 102 may send additional data or other information to the base station 104 via a PUSCH. The PUSCH includes RRC communications, uplink control information (UCI) messages, and application data. The PUSCH is typically the channel on which application data is transmitted from the user device 102 to the base stations 104 or 202. Alternately or additionally, the base stations 104 or 202 may send additional data to the user device 102 via a PHICH. The PHICH includes a request for acknowledgements or lack of acknowledgements for data received from the user device 102 via the PUSCH.

FIG. 3 illustrates an example of network communication or operations at 300 in accordance with one or more aspects of inter-radio access technology carrier aggregation. In this example, the user device 102 transmits a user device-initiated inter-RAT communication 302 to the base station 104 via the uplink component carrier 208. The user device 102 also receives a base station-initiated inter-RAT communication from the base station 104 via the downlink component carrier 210. The user device 102 transmits, via an uplink (UL) component carrier 304, user device-initiated application data 306. The base station transmits, via the downlink component carrier 212, base station-initiated application data 308.

In an example implementation, the user device 102, the base station 104, and the base station 202 form a wireless link of a wireless network. The user device 102 and the base station 104 communicate via a first component carrier using a 4G LTE RAT. The first component carrier (the uplink component carrier 208 and the downlink component carrier 212, collectively) is used to communicate data between the user device 102 and the wireless network. The communicated data includes communication data for a second component carrier using a 5G NR RAT that facilitates communication between the user device 102 and the base station 202. In some implementations, the communication data for the second component carrier are aggregated with communication data for the first component carrier. These aggregated communication data may be transmitted efficiently via a communication channel of the first component carrier, such as the PUCCH.

The second component carrier (the uplink component carrier 304 and the downlink component carrier 212, collectively) can reduce an amount of resources used for communicating communication data, and can therefore increase an amount of resources for communicating application data. In this example, an increased efficiency of communicating communication data for both of the carrier components may improve a net bandwidth for communicating application data.

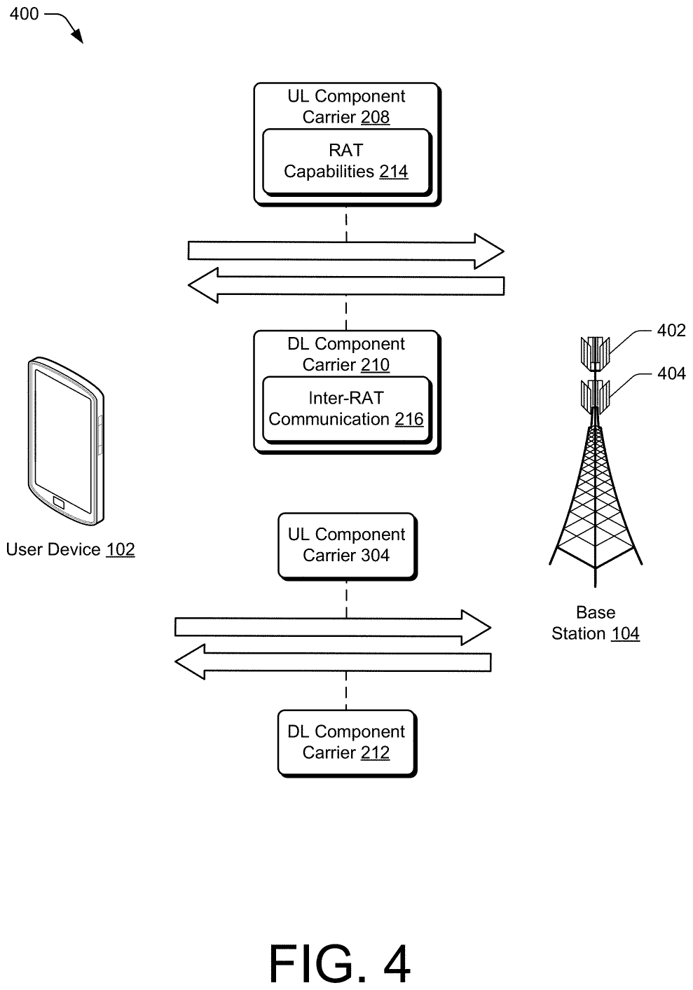

FIG. 4 illustrates another example of network communication or operations 400 in accordance with one or more aspects of inter-radio access technology carrier aggregation. In this example, the base station includes a first transceiver 402 and a second transceiver 404. The base station 104 communicates with the user device 102 via the first transceiver 402 using the uplink component carrier 208 and the downlink component carrier 210, which operate according to a first RAT. The base station 104 communicates with the user device 102 via the second transceiver 404 using the uplink component carrier 208 and the downlink component carrier 212, which operate according to a second RAT.

Based on the RAT capabilities 214 of the user device 102, the base station 104 manages communication data for the second component carrier of the second RAT via the inter-RAT communications 214 communicated via the first component carrier of the first RAT. Using the base station inter-RAT carrier aggregation module 126, for example, the base station 104 manages communications of the first component carrier and the second component carrier to aggregate transmission and receipt of communication data.

In some implementations, the first component carrier facilitates communication of application data between the user device 102 and the base station 104 in addition to the communication data of the first component carrier and the second component carrier.

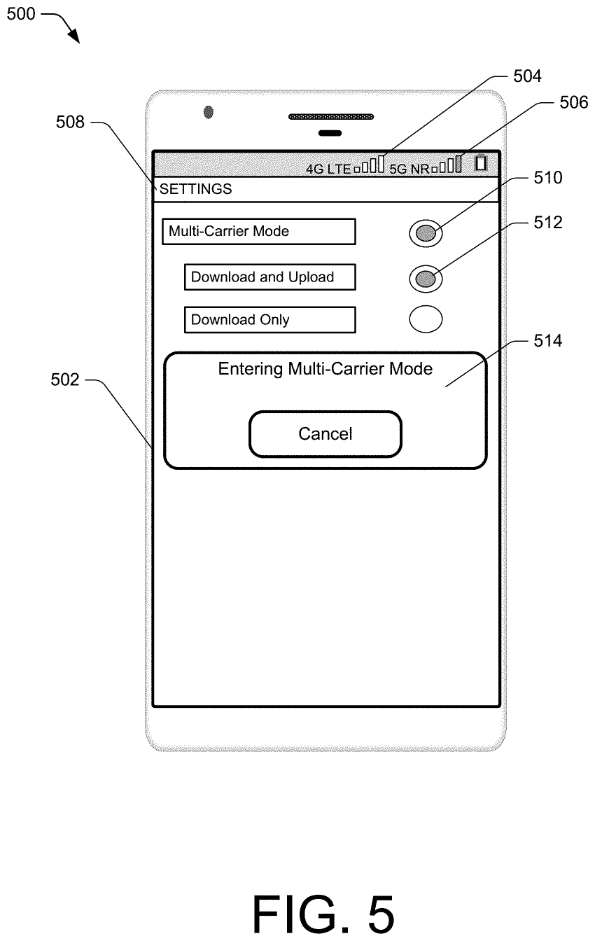

FIG. 5 illustrates an example user interface 500 of the user device 102 through which one or more aspects of inter-radio access technology carrier aggregation can be implemented. In this example, the user interface 500 is presented through a visible portion of a display 502 for providing output to a user. The display 502 may also include, or be integrated with, a touch screen or touch-sensitive overlay for receiving touch input from the user. The display 502 may also display a signal-quality indicator 504 of the first carrier component of the first RAT (shown as 4G LTE) and a signal-quality indicator 506 of the second carrier component of the second RAT (shown as 5G NR). In some cases, the display 502 provides or makes accessible a settings menu 508 through which the user interface 500 can receive input 510 to select a multi-carrier communication mode. For example, the settings menu 508 for the multi-carrier communication modes can receive an input 512 to request one or more modes, such as a download and upload mode or a download only mode.

Upon receiving a selection to request a multi-carrier mode, the user device may transmit, to the base station 104, a request to enter a multi-carrier mode via a first component carrier. The request may include the RAT capabilities 214 of the user device 102. A transceiver of the base station 104 communicates the request to the base station inter-RAT carrier aggregation module 126, another base station, such as the base station 202, or the MME 206. The transceiver of the base station 104 then communicates the inter-RAT communication 216 that is usable by the user device 102 to configure a transceiver of the user device 102 for communication via the second component carrier.

Alternately or additionally, the user device 102 may provide a notification 514 via the user interface 500 to indicate that the user device 102 is entering the multi-carrier mode, based on a receipt of the inter-RAT communication 216. The notification 514 is illustrated in this example as a pop-up notification in the display 502, however, other forms of notification 514 may be implemented in addition or in alternative to the pop-up notification. For example, the user device 102 may provide an audible notification, a visible notification via a light emitting diode (LED) indicator that is separate from the display 502, or a motion-based notification such as a vibration of the user device 102.

The user interface 500 is but one of many possible user interfaces for implementing inter-RAT carrier aggregation. Although the user device 102 is illustrated as a smart phone with a touch screen, alternative user interfaces may be implemented by the user device 102. For example, the user device 102 may be implemented as a laptop with a user interface including, for example, one or more of a mouse, a track pad, a keyboard, a microphone, a monitor, a projector screen, or speakers. In some implementations, the user interface does not include the settings menu 508 for receiving the inputs 508 or 510, but rather, the user device 102 enters the multi-carrier mode automatically and without receiving user input.

Techniques for Inter-RAT Carrier Aggregation

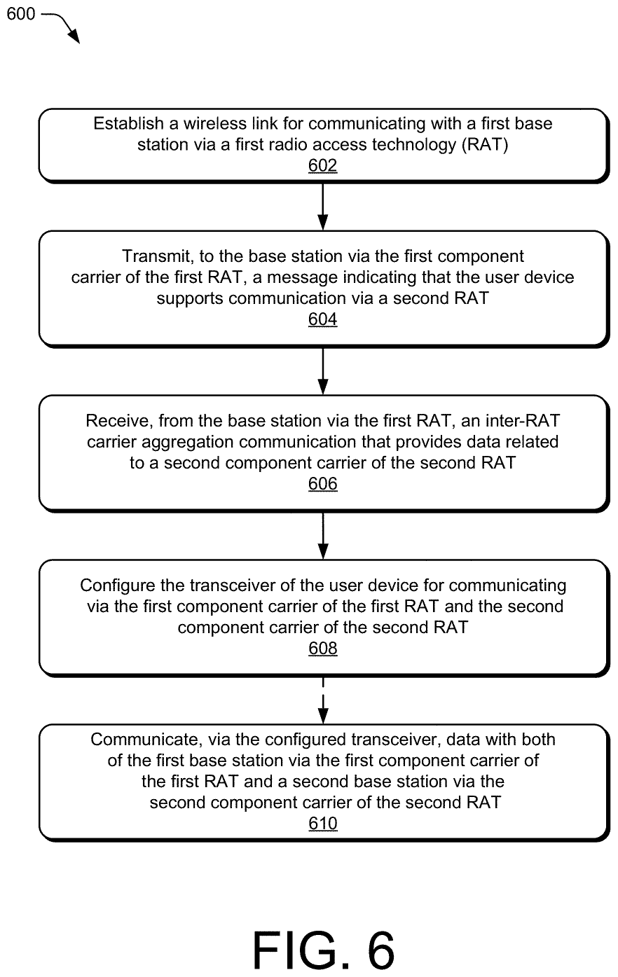

FIGS. 6-8 depict methods for implementing inter-RAT carrier aggregation in wireless networks. These methods are shown as sets of blocks that specify operations performed but are not necessarily limited to the order or combinations shown for performing the operations by the respective blocks. For example, operations of different methods may be combined, in any order, to implement alternate methods without departing from the concepts described herein. In portions of the following discussion, the techniques may be described in reference to FIGS. 1-5, reference to which is made for example only. The techniques are not limited to performance by one entity or multiple entities operating on one device, or those described in these figures.

FIG. 6 illustrates an example method 600 for inter-radio access technology carrier aggregation, including operations performed by an inter-RAT carrier aggregation module, such as the Inter-RAT CA module 116. In some aspects, operations of the method 600 may be implemented to improve efficiency of transmitting and receiving communication data for a wireless link including two or more component carriers using different RATs.

At operation 602, a user device establishes, via a transceiver of the user device, a wireless link for communicating with a first base station via a first radio access technology (RAT). For example, the user device 102 establishes a wireless link for communicating with the base station 104 via the first component carrier. The first component carrier includes the uplink component carrier 208 and the downlink component carrier 210.

At operation 604, the user device transmits, to the base station and via the first component carrier of the first RAT, a message indicating that the user device supports communication via a second RAT. For example, the user device 102 transmits the RAT capabilities 214 of the user device 102 to the base station 104. In some implementations, the first component carrier uses any RAT and the second component carrier uses any other RAT, such that the first RAT and the second RAT are different. In some examples, the first component carrier uses a 4G LTE RAT and the second component carrier uses a 5G NR RAT. Alternatively, the first component carrier uses a 5G NR RAT and the second carrier uses a 4G LTE RAT.

At operation 606, the user device receives, from the first base station via the first RAT, an inter-RAT carrier aggregation communication that provides data related to the second component carrier of the second RAT. In some implementations, the inter-RAT communication includes a downlink schedule, channel configuration instructions, hand-off instructions, or other communication data that would otherwise be transmitted via a downlink of the second component carrier. The inter-RAT communication may be transmitted semi-statically at predicted intervals, or may be transmitted dynamically based on a change of status of the base station or the user device. For example, the user device 102 receives, from the base station 104, the inter-RAT communication 216 via the downlink component carrier 210.

At operation 608, the transceiver of the user device is configured for communicating via a first component carrier of the first RAT and via the second component carrier of the second RAT. For example, the user device 102 configures one or more transceivers of the communication module 120 for communicating with the first base station 104 via the first component carrier using a first RAT and with the second base station 202 via the second component carrier using a second RAT. The user device 102 may be configured to communicate via a downlink only with one of the first base station 104 or the second base station 202.

At optional operation 610, the user device communicates, via the configured transceiver, data with both of the first base station and a second base station. The configured transceiver communicates data with the first base station via the first component carrier of the first RAT. The configured transceiver additionally communicates with the second base station via the second component carrier of the second RAT. For example, a transceiver of the communication module 120 communicates with the base station 104 via the uplink component carrier 208 and the downlink component carrier 210. The transceiver of the communication module 120 also communicates with the base station 202 via the downlink component carrier 212.

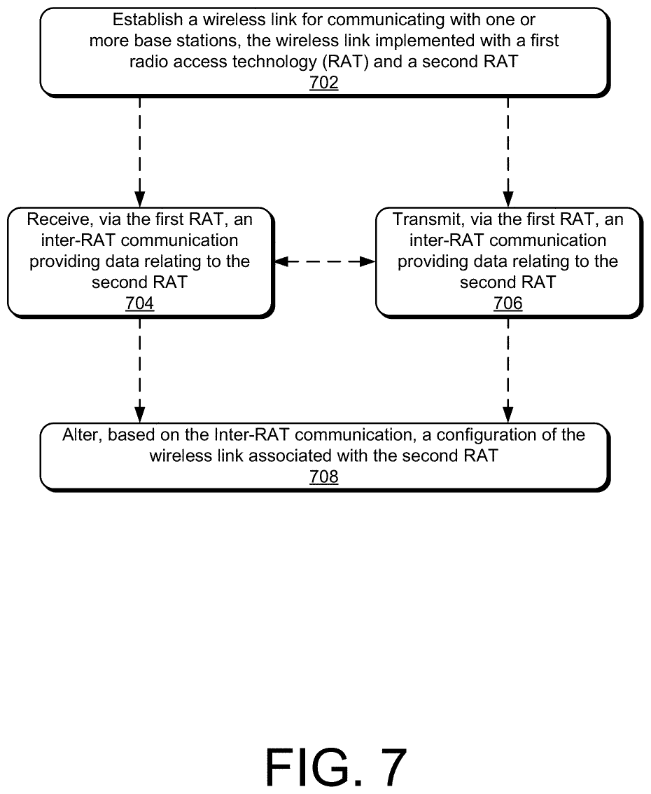

FIG. 7 illustrates an example method 700 for inter-radio access technology carrier aggregation, including operations performed by an inter-RAT carrier aggregation module, such as the inter-RAT carrier aggregation module 116. In some aspects, operations of the method 700 may be implemented to improve efficiency of transmitting and receiving communication data for a wireless link including two or more component carriers using different RATs.

At operation 702, a user device establishes, via a transceiver of the user device, a wireless link for communicating with one or more base stations. The wireless link is implemented with a first RAT and a second RAT. The first RAT and the second RAT are different types of RAT, such as 4G LTE and 5G NR, respectively. For example, the user device 102 establishes a wireless link for communicating with the base station 104 via the first component carrier of the first RAT including the uplink component carrier 208 and the downlink component carrier 210 and with the base station 202 via the first component carrier of the second RAT including at least the downlink component carrier 212.

At operation 704, the user device receives, from the base station via the first RAT, an inter-RAT communication that provides data related to the second RAT. For example, the user device 102 receives, from the base station 104, the inter-RAT communication 216 via the downlink component carrier 210 of the first RAT. The inter-RAT carrier aggregation communication 216 includes communication data for the second component carrier of the second RAT.

At operation 706, the user device transmits, to the base station via the first RAT, an inter-RAT communication that provides data related to the second RAT. For example, the user device 102 transmits, via the uplink component carrier 208, the inter-RAT communication 302 including communication data relating to the component carrier of the second RAT including at least the downlink component carrier 212. As illustrated, the operation 706 may be performed before, after, or in alternative to the operation 704. In some implementations, the operation 706 is performed in response to performance of operation 704. In other implementations, the operation 704 is performed in response performance of the operation 706.

At operation 708, a configuration of the wireless link associated with the second RAT is altered. The altering is based at least in part on one or both inter-RAT communications of operations 704 or 706. For example, the user device 102 configures one or more transceivers of the communication module 120 for future communications with the second base station 202 via the second component carrier. In particular, the user device 102 may alter a maximum power amplification setting for communicating via the second component carrier. In another particular example, the user device 102 may configure one or more transceivers of the communication module 120 to follow an updated hopping pattern for communicating via the second component carrier.

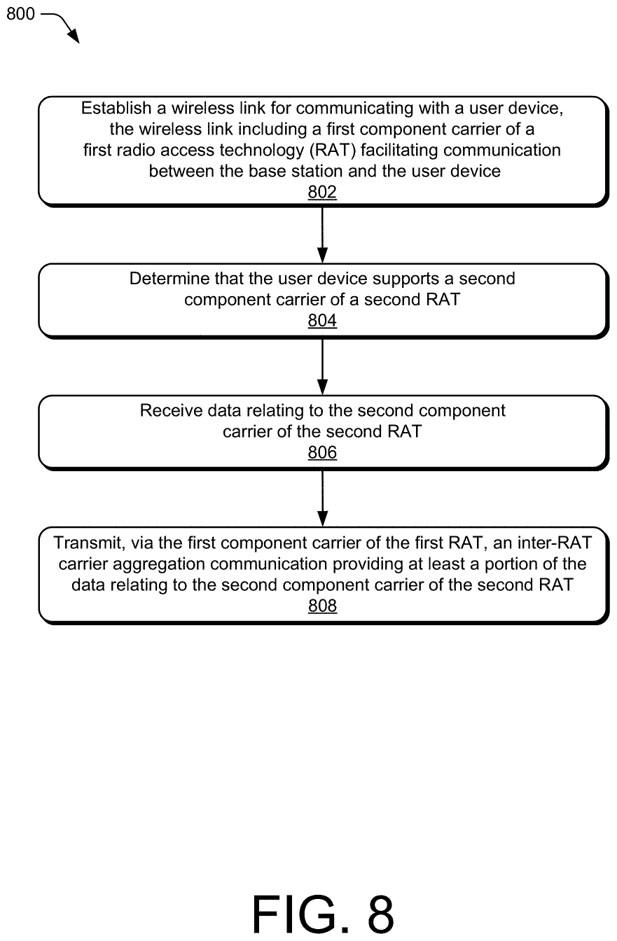

FIG. 8 illustrates an example method 800 for inter-radio access technology carrier aggregation, including operations performed by an inter-RAT carrier aggregation module, such the base station Inter-RAT CA module 126. In some aspects, operations of the method 800 may be implemented to improve efficiency of transmitting and receiving communication data for a wireless link including two or more component carriers using different RATs.

At operation 802, a base station establishes, via a transceiver of the base station, a wireless link for communicating with a user device. The wireless link includes a first component carrier of a first radio access technology (RAT) facilitating communication between the base station and the user device. For example, the base station 104 establishes a wireless link for communicating with the user device 102 via the first component carrier including the uplink component carrier 208 and the downlink component carrier 210. The first component carrier may use a 4G LTE RAT and the second component carrier may use a 5G NR RAT. Alternatively, the first component carrier may use a 5G NR RAT and the second carrier may use a 4G LTE RAT.

At operation 804, the base station determines that the user device supports a second component carrier of the second RAT. For example, the base station 104 receives the RAT capabilities 214 of the user device 102 via the uplink component carrier 208 of the first component carrier. At operation 806, the base station receives data relating to the second component carrier of the second RAT. For example, the base station 104 may receive the wireless link data 218 from the base station 202, which provides the second component carrier including the downlink component carrier 212. Alternatively, the base station 104 receives the wireless link data 218 from the MME 206, which coordinates communications of the base stations 104 and 202 with the user device 102.

At operation 808, the base station transmits, to the user device via the first component carrier of the first RAT, an inter-RAT carrier aggregation communication in accordance with the first RAT. The inter-RAT carrier aggregation communication provides at least a portion of the data relating to the second component carrier of the second RAT. The portion of the data is useable by the user device to configure a transceiver of the user device for future communication via the second component carrier of the second RAT. For example, the base station 104 transmits, to the user device 102, the inter-RAT communication 216 via the downlink component carrier 210. The inter-RAT carrier aggregation communication includes communication data for the second component carrier.

Although techniques using, and apparatuses for implementing, inter-RAT carrier aggregation have been described in language specific to features or methods, it is to be understood that the subject of the appended claims is not necessarily limited to the specific features or methods described. Rather, the specific features and methods are disclosed as example ways in which inter-radio access carrier aggregation can be implemented.

1.-22. (canceled)

23. A method performed by a user device, the method comprising:
establishing, via a transceiver of the user device, a wireless link with a first base station via a first radio access technology (RAT);
transmitting, to the first base station via the first RAT, a message indicating that the user device supports communication via a second RAT, the second RAT being different from the first RAT;
receiving, from the first base station via the first RAT, an inter-RAT carrier aggregation communication that indicates data related to:
establishing inter-RAT carrier aggregation using a first component carrier of the first RAT and a second component carrier of the second RAT, the data indicating an orthogonal frequency-division multiplexing (OFDM) numerology of the second component carrier; and
performing inter-RAT carrier aggregation operations using the first component carrier and the second component carrier;
configuring, based at least in part on the inter-RAT carrier aggregation communication, the transceiver of the user device for performing a first portion of the inter-RAT carrier aggregation operations that use the first component carrier of the first RAT;
configuring, based at least in part on the inter-RAT carrier aggregation communication, the transceiver of the user device for performing a second portion of the inter-RAT carrier aggregation operations that use the second component carrier of the second RAT; and
exchanging, via the configured transceiver, information with both the first base station via the first component carrier of the first RAT and a second base station via the second component carrier of the second RAT using the inter-RAT carrier aggregation operations.

24. The method as recited in claim 23, wherein receiving the inter-RAT carrier aggregation communication further comprises:
receiving, as part of the inter-RAT carrier aggregation communication, antenna information.

25. The method as recited in claim 23, wherein receiving the inter-RAT carrier aggregation communication further comprises:
receiving, as part of the inter-RAT carrier aggregation communication, an identification of the second RAT.

26. The method as recited in claim 23, wherein receiving the inter-RAT carrier aggregation communication further comprises:
receiving, as part of the inter-RAT carrier aggregation communication, a carrier activation message via a medium access control (MAC) control element.

27. The method as recited in claim 23, wherein receiving the inter-RAT carrier aggregation communication further comprises:
receiving, as part of the inter-RAT carrier aggregation communication, a carrier deactivation message via a medium access control (MAC) control element.

28. The method as recited in claim 23 further comprising:
receiving a second inter-RAT carrier aggregation communication that includes additional data for the inter-RAT carrier aggregation, the additional data comprising at least one of:
timing advance information for communication via the second component carrier;
a power control command for communication via the second component carrier; or
an indication that the first base station supports carrier aggregation communications.

29. The method as recited in claim 23 further comprising:
receiving a second inter-RAT carrier aggregation communication that includes additional data for the inter-RAT carrier aggregation, the additional data comprising handover data usable to transfer the second component carrier from the second base station to a third base station.

30. The method as recited in claim 23, wherein receiving the inter-RAT carrier aggregation communication further comprises:
receiving, as part of the inter-RAT carrier aggregation communication, a downlink schedule for the second component carrier.

31. The method as recited in claim 23, wherein receiving the inter-RAT carrier aggregation communication further comprises:
receiving, as part of the inter-RAT carrier aggregation communication, channel configuration instructions that direct the user device to configure one or more additional channels for communication via the first component carrier or the second component carrier.

32. The method as recited in claim 31, wherein receiving the channel configuration instructions further comprises:
receiving channel configuration instructions that direct the user device to configure another hybrid automatic repeat requests (HARQ) indicator channel (PHICH) for communication via the second component carrier.

33. A user device comprising:
a hardware-based transceiver; and
an inter-radio access technology carrier aggregation (Inter-RAT CA) module configured to perform inter-RAT carrier aggregation operations comprising:
establishing, via the transceiver of the user device, a wireless link with one or more base stations, the wireless link including:
a first component carrier of a first radio access technology (RAT) for performing a first portion of the inter-RAT carrier aggregation operations; and
a second component carrier of a second RAT for performing a second a portion of the inter-RAT carrier aggregation operations, the second RAT being different from the first RAT;
exchanging, via the transceiver, information with the one or more base stations via the first component carrier of the first RAT and via the second component carrier of the second RAT using the inter-RAT carrier aggregation operations;
receiving, from the one or more base stations and via the first component carrier of the first RAT, an inter-RAT carrier aggregation communication that provides providing data relating to the second component carrier of the second RAT, the data indicating an orthogonal frequency-division multiplexing (OFDM) numerology of the second component carrier; and
altering, in response to receiving the inter-RAT carrier aggregation communication, a configuration of the second component carrier of the second RAT.

34. The user device as recited in claim 33, wherein receiving the inter-RAT carrier aggregation communication further comprises:
receiving, as part of the inter-RAT carrier aggregation communication, antenna information.

35. The user device as recited in claim 33, wherein receiving the inter-RAT carrier aggregation communication further comprises:
receiving, as part of the inter-RAT carrier aggregation communication, timing advance information for communication via the second component carrier or a power control command for communication via the second component carrier.

36. The user device as recited in claim 33, wherein receiving the inter-RAT carrier aggregation communication further comprises:
receiving, as part of the inter-RAT carrier aggregation communication, a downlink schedule for the second component carrier.

37. A method performed by a base station of a wireless network, the method comprising:
establishing, via a transceiver of the base station, a wireless link for communicating with a user device, the wireless link including a first component carrier of a first radio access technology (RAT) facilitating communication between the base station and the user device;
determining that the user device supports a second component carrier of a second RAT;
receiving, from another device of the wireless network, data relating to the second component carrier of the second RAT; and
transmitting, to the user device via the first component carrier of the first RAT, an inter-RAT carrier aggregation communication that enables the base station to communicate with the user device using inter-RAT carrier aggregation operations, the inter-RAT carrier aggregation communication providing at least a portion of the data relating to the second component carrier of the second RAT, the portion of the data usable by the user device to configure a transceiver of the user device for communicating using inter-RAT carrier aggregation via the first component carrier of the first RAT and the second component carrier of the second RAT, the portion of the data including an orthogonal frequency-division multiplexing (OFDM) numerology of the second component carrier.

38. The method as recited in claim 37, wherein transmitting the inter-RAT carrier aggregation communication further comprises:
transmitting, in the portion of the data relating to the second component carrier of the second RAT, antenna information.

39. The method as recited in claim 37, wherein transmitting the inter-RAT carrier aggregation communication further comprises:
transmitting, in the portion of the data relating to the second component carrier of the second RAT, timing advance information for communication via the second component carrier.

40. The method as recited in claim 37, wherein transmitting the inter-RAT carrier aggregation communication further comprises:
transmitting, in the portion of the data relating to the second component carrier of the second RAT, a power control command for communication via the second component carrier.

41. The method as recited in claim 37, wherein transmitting the inter-RAT carrier aggregation communication further comprises:
transmitting, in the portion of the data relating to the second component carrier of the second RAT, a downlink schedule for the second component carrier.

42. The method as recited in claim 37, wherein transmitting the inter-RAT carrier aggregation communication further comprises:
transmitting, in the portion of the data relating to the second component carrier of the second RAT, channel configuration instructions that direct the user device to configure one or more additional channels for communication via the second component carrier.
